(19) United States
(12) Patent Application Publication
(10) Pub. No.: US 2019/0176010 A1
(43) Pub. Date: Jun. 13, 2019

(54) BOARD DISPLAY SYSTEM

(71) Applicant: Ori DADOOSH, Tel Aviv (IL)

(72) Inventor: Ori DADOOSH, Tel Aviv (IL)

(21) Appl. No.: 16/211,535

(22) Filed: Dec. 6, 2018

Related U.S. Application Data
(60) Provisional application No. 62/595,685, filed on Dec. 7, 2017.

(51) Int. Cl. A63B 71/00; F16M 13/02; G08B 5/00

(52) U.S. Cl. CPC A63B 71/0036; F16M 2200/08; G08B 5/00; F16M 13/02

(57) ABSTRACT

The disclosure is directed to a display apparatus and system for displaying and using elongated boards secured in a three dimensional space.

### CROSS-REFERENCE TO RELATED APPLICATIONS

This application claims priority under 35 U.S.C. § 119(e) to U.S. Provisional Patent Application No. 62/595,685, filed Dec. 7, 2017, and entitled “Board Display System”, the disclosure of which is expressly incorporated by reference herein in its entirety.

### BACKGROUND OF THE INVENTION

The disclosure relates to devices and systems for displaying elongated boards and providing real time information pertinent to users of the elongated board. Specifically, the disclosure relates to a system for securing elongated boards while providing real time input pertinent to the use of the elongated boards.

Typically users of elongated boards, such as surf boards, stand up paddle boards, long boards and the like, use passive display shelves and brackets that beyond mechanically engaging the elongated board are inactive.

Further, enthusiasts of sports associated with these elongated boards typically depend on real-time environmental conditions to maintain their involvement in their respective activities. Such information is rapidly changing and, beyond the need for real-time information from multiple sources, may require the ability to source input from multiple interrelated sources.

In addition, embedding various sensors into the elongated boards, when those are properly located in areas of the boards determined to provide valuable information, can be used to provide training information, refereeing information and other key-performance indicators for the user. Moreover, when these sensors are networked through industrial internet of things (IIoT), it may be needed to have a docking station capable of downloading the information stored on the sensors, or otherwise charging the sensors.

These and other aspects of the technology are disclosed herein.

### BRIEF SUMMARY

In an embodiment, provided herein are systems devices and/or methods for displaying and interacting with other elongated boards users while simultaneously receiving real time environmental conditions pertinent to the user of the elongated board.

In an embodiment, provided herein is an elongated board display apparatus, wherein the elongated board has a dorsal side and a ventral side, the apparatus comprising: a base; a tilted elongated support member having a longitudinal axis, a proximal end coupled to the base and a flared distal end configured to abut the elongated board, wherein the tilted elongated support member defines a slit in parallel with the support member's longitudinal axis, wherein: the tilt is configured to fix the board at a predetermined pitch angle; the flared distal end is configured to fix the elongated board at a predetermined roll angle; and The slit is configured to receive and engage a ventral member on the board and fix the elongated board at a predetermined yaw angle; a transceiver operably coupled to the support member or the base; a display operably coupled to the support member or the base: a non-volatile memory, having thereon a computer readable media with executable set of instructions; a processor operably coupled to the support member or the base, the processor being in communication with the memory, the transceiver and the display; and a power source.

In another embodiment, provided herein is an elongated surfboard display apparatus, wherein the elongated board has a dorsal side and a ventral side, the apparatus comprising: a triangular base having a raised wide anterior facet and a narrow posterior side; and a tilted V-shaped support member having a basal edge and an apical edge, defining an apically flared slit with a basal end, configured to receive and engage a posterior ventral fin of the elongated surfboard; and a resilient strip operably coupled to the apical edge of the V-shaped support member.

In yet another embodiment, provided herein is a surfing system comprising: a display apparatus comprising: a base; a tilted elongated support member having a longitudinal axis, a proximal end coupled to the base and a flared distal end configured to abut the elongated board, wherein the tilted elongated support member defines a slit in parallel with the support member's longitudinal axis, wherein: the tilt is configured to fix the board at a predetermined pitch angle; the flared distal end is configured to fix the elongated board at a predetermined roll angle; and The slit is configured to receive and engage a ventral member on the board and fix the elongated board at a predetermined yaw angle; a transceiver operably coupled to the support member or the base; a display operably coupled to the support member or the base: a non-volatile memory, having thereon a computer readable media with executable set of instructions; a processor operably coupled to the support member or the base, the processor being in communication with the memory, the transceiver and the display; and a power source; an application gateway server; a mobile device; an environmental condition server; a database, wherein the apparatus, the application server the mobile device, and the environmental conditions server are each in two way communication with each other over a wide area network.

Various advantages, aspects and novel features of the disclosed technology, as well as details of an illustrated embodiment thereof, will be more fully understood from the following description and drawings.

### BRIEF DESCRIPTION OF SEVERAL VIEWS OF THE DRAWINGS

Some embodiments of the disclosed technology are described herein by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. In the drawings:

FIG. 1 illustrates an embodiment of the front elevation view of the display stand used in the systems described:

FIG. 2, illustrates an embodiment of a side elevation view thereof;

FIG. 3, illustrates an embodiment of a top front right perspective view thereof;

FIG. 4, illustrates an embodiment of a top left rear perspective view thereof;

FIG. 5, illustrates an embodiment of the predetermined pitch angle in an embodiment of a surfboard displayed on the stand;

FIG. 6, illustrates an embodiment of the predetermined yaw angle of a surfboard displayed on the stand;

FIG. 7A illustrates another embodiment of a perspective view of a surfboard display apparatus, with side elevation view in FIG. 7B, a front elevation view illustrated in FIG. 7C, and the double triangle configuration schematic illustrated in FIG. 7D;

FIG. 8A, illustrates another embodiment of the predetermined yaw angle of a surfboard displayed on the display apparatus, with side elevation view of the intended 3-fins surfboard illustrated in FIG. 8B;

FIG. 9, illustrates the display system components and their interrelations;

FIG. 10, illustrates an embodiment of the system's client feedback method; and

FIG. 11, illustrates an embodiment of the system's server feedback method.

### DETAILED DESCRIPTION

The present disclosure, in some embodiments thereof, relates to an elongated board display systems and methods of use.

The apparatus embodiments described herein provide a mechanical solution to the need for decorative displaying, storing, and safely mounting of elongated boards. The apparatus can be configured to display a single surfboard in a decorative and elegant way, while protecting the surfboard while not in use. The apparatus is configured to have minimal foortprint. Furthermore, the surfboard and the product, when engaged, shall function as a monolith with no relative movement between the board and the apparatus. A stable equilibrium shall be established, assuming reasonable use, within the base triangle area for all degrees of freedom regarding pitch, roll, and yaw.

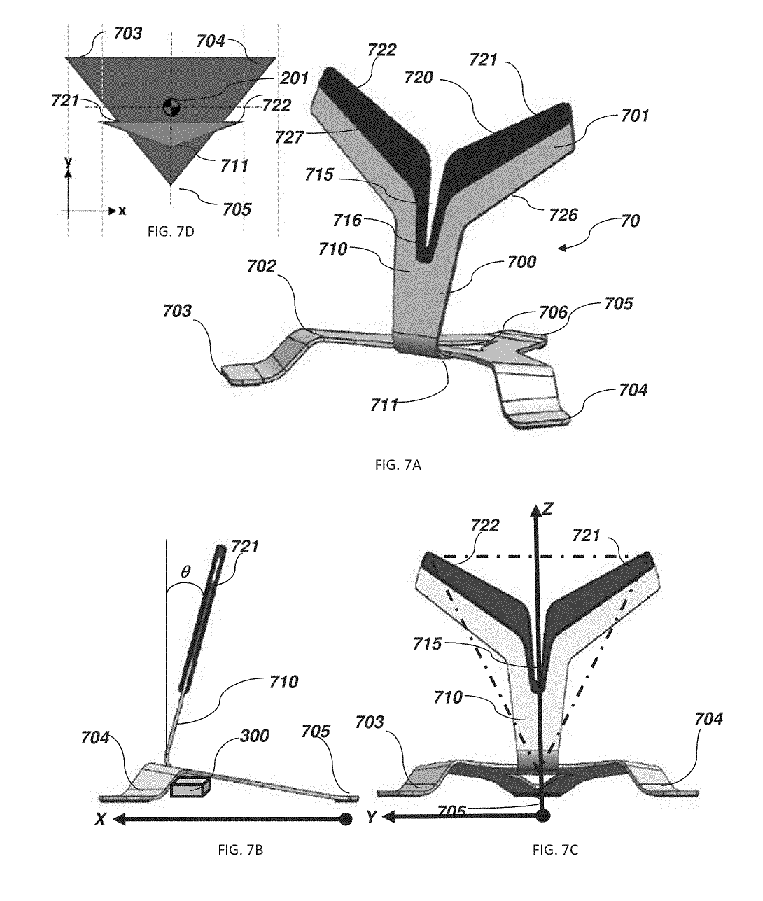

As shown in FIG. 7D, the apparatus can be enabled by combining two generally triangular surfaces, a base and a tilted support member, each represented by 3 points in space (triangles). The base is configured to maintain full and constant contact with the ground, while the tilted support member (which can be fixedly coupled to the base, or be a separate member operably coupled to the base), shall secure the surfboard in a given 3D configuration in space, while ensuring the center of mass (surfboard+product) is substantially (nominal) above the center of the base (see e.g., FIG. 7D).

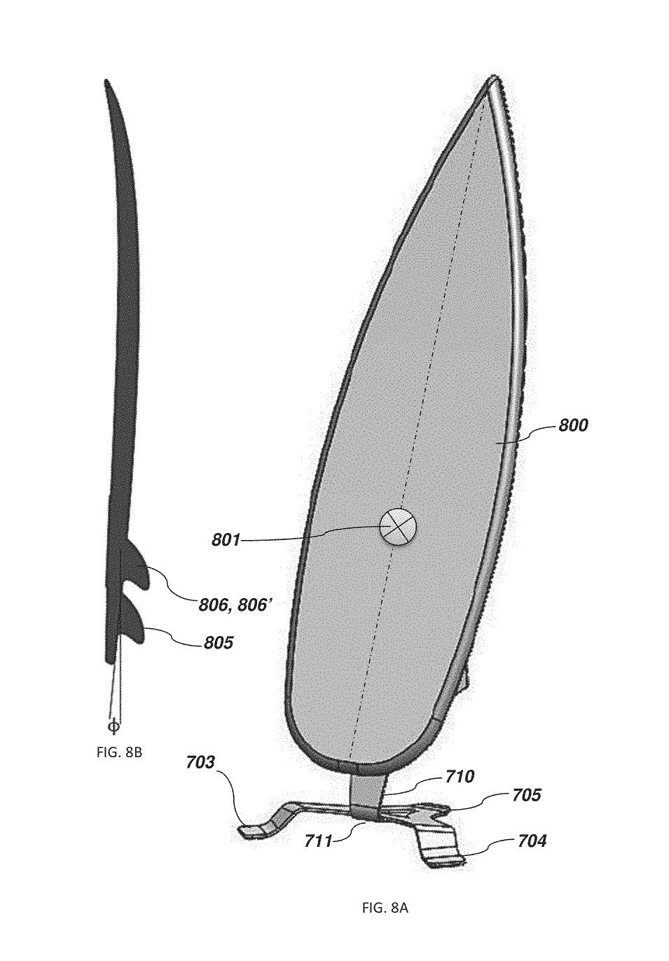

Furthermore, the display apparatus embodiments can be configured so as to be compatible with various boards' sizes and weight ranges, as well as various shapes (e.g., shortboard, fish shapes) and be able to accommodate all tail shapes. As illustrated in FIG. 7A, the display apparatus can be further compatible with the Thruster (3 fin) fin configuration (see e.g., FIG. 8B). In addition, the display apparatus can be configured to accommodate a common leash wrapping method around the board while in storage.

A more complete understanding of the components, methods, and devices disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof, their relative size relationship and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function. Likewise, when present, cross sections are referred to on normal orthogonal coordinate system having XYZ axis, such that Y axis refers to front-to-back, X axis refers to side-to-side, and Z axis refers to up-and-down.

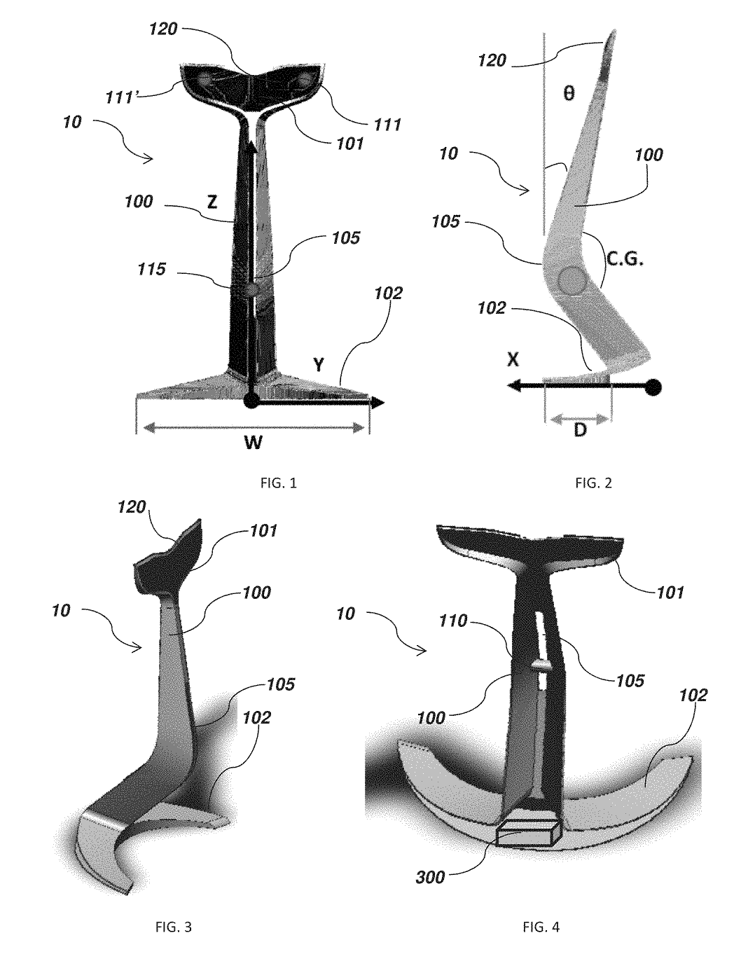

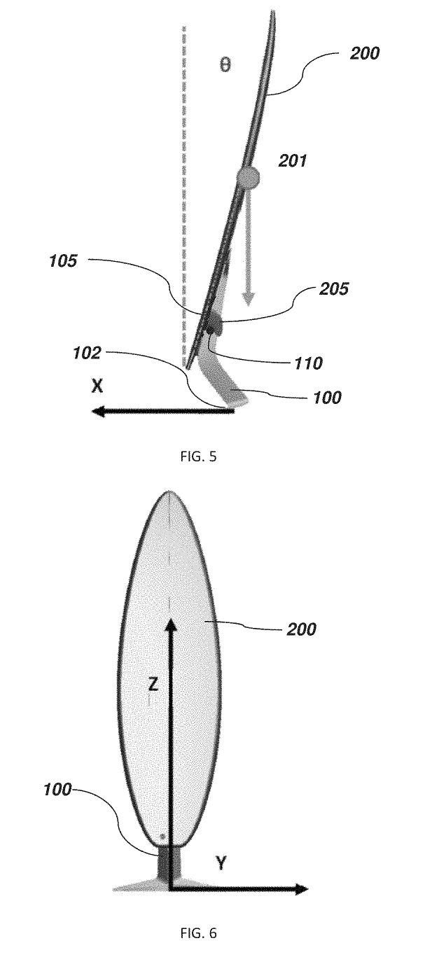

Turning now FIGS. 1-6, illustrating elongated board display apparatus 10, wherein the elongated board (see e.g., 200 FIG. 5) has a dorsal side and a ventral side. As shown in FIG. 1, apparatus 10 comprising: base 102; tilted elongated support member 100 having a longitudinal axis, a proximal end coupled to base 102 and flared distal end 101 configured to abut elongated board 200 (see e.g., FIG. 6), wherein tilted elongated support member 100 defines slit 105 in parallel with support member's 100 longitudinal axis, wherein: the tilt in elongated support member 100 can be configured to fix board 200 (see e.g., FIG. 5) at a predetermined pitch angle θ (see e.g., FIG. 5). Flared distal end 101 can be configured to fix elongated board 200 (see e.g., FIG. 6) at a predetermined roll angle. Likewise slit 105 can be configured to receive and engage ventral member (e.g., 205, FIG. 5) on board 200 and fix elongated board 200 (FIG. 5) at a predetermined yaw angle. The display can further comprise transceiver 300 operably coupled to support member 100 or base 102; a display operably coupled to support member 100 or base 102 (not shown): a non-volatile memory, having thereon a computer readable media with executable set of instructions (not shown); a processor operably coupled to support member 100 or base 102, the processor being in communication with the memory, transceiver 300 and the display; and a power source (not shown). In an embodiment, the term “abut” or abutting, as used herein, has meaning that includes, but is not limited to, being proximate to, or in direct contact without interfering layer.

In an embodiment, the stand can have the dimensions described in Table 1.

TABLE 1
Display Apparatus Dimensions

| Board Pitch Angle | θ | 5°-45° | |
|---|---|---|---|
| Board Weight | M | 1-6 | [kg] |
| Device weight | m | 0.3-5 | [kg] |
| Base width | W | 30-60 | [cm] |
| Base Depth | D | 20-60 | [cm] |
| Lower point [x] | Xₗₚ | 20-40 | [cm] |
| Lower point [y] | Yₗₚ | 0 ± 1 | [cm] |
| Lower point [z] | Zₗₚ | 5-30 | [cm] |
| Upper Pads [x] | Xᵤₚ | 5-20 | [cm] |
| Upper Pads [z] | Zᵤₚ | 30-60 | [cm] |
| Right Pad [y] | Y_{upR} | 5-30 | [cm] |
| Left Pad [y] | Y_{upL} | (−5)-(−30) | [cm] |
| Board C.G. (along board from | B_{cg} | 0.5-1.5 | [m] |
| bottom) | | | |
| Device C.G. [x] | X_{c.g} | 5-30 | [cm] |
| Device C.G. [y] | Y_{c.g} | 0 ± 1 | [cm] |
| Device C.G. [z] | Z_{c.g} | 0-50 | [cm] |

Tilted support member 100 can define an elbow (see e.g., FIG. 2) along the longitudinal axis and wherein slit 105 spans the elbow. The elbow can be located at the center of gravity thus provide stability to stand 10. Elongated board 200 (see e.g., FIG. 6) is configured to contact apparatus 10 at three points. Two points 111, 111′ on pads 120 disposed on distal end 101 of tilted support member 100, and point 115 (FIG. 1). Turning now to FIG. 4, illustrating tilted support member 100 having a front and a back, further comprising bar 100 disposed transverse to tilted support member's 100 longitudinal axis (see Z, FIG. 1). Bar 110 can be coupled to tilted support member 100 at the elbow and can be accessible through slit 105. Pads 120 can be formed of a high friction, resilient material configured to engage the ventral side of elongated board 200 and secure elongated board 200 at a predetermined roll angle.

In an embodiment, tilted support member 100 can be rotatably coupled to base 102 and to flared distal end 101. Moreover, tilted support member 100 can have an articulation joint rotating thus altering pitch angle at transverse member 110.

In an embodiment, elongated board 200, can be a surfboard, a stand-up paddle, a skate board, a long board, or a street luge board having a dorsal side (or upper surface, usually for carrying a user), a ventral side (usually having either a fin or wheels/trucks coupled thereto), a front end and a back end. Display apparatus 10 described herein can be configured to display the dorsal side of the elongated board. Also, ventral member 205 (see e.g., FIG. 5) refers to any protrusion from the ventral side of the elongated board, whether integral to the board or coupled thereon for the purpose of engaging the display to secure the board in a three-dimensional space as described herein. The term “secure” refers in an embodiment to provisions made to prevent the elongated board from undesired change in its pitch, yaw and rotation position in space once that position has been predetermined.

Display apparatus 10 can further comprise a sensor (not shown) configured to detect and communicate presence or absence of the elongated board on the apparatus. For example, the sensor could be disposed on each side of slit 105, detecting insertion and removal of elongated board 200 ventral member 205 (see e.g., FIG. 5). Alternatively, detection of presence or absence of elongated board 200 on display apparatus 10 can be by detecting load on transverse member 110, using for example a piezoelectric body, proximity sensor, or a load cell. A skilled artisan would readily recognize that other sensors or combination of sensors can be used to detect the presence or absence of elongated board 200 on display apparatus 10. The signal generated can then be communicated to a remotely located receiver, or a transceiver located on display apparatus 10, which can then relay the signal to a remote receiver.

The methods described herein, can be used in conjunction with the systems for displaying and using elongated board 200.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. As described herein, a procedure, logic block, process, or the like, is conceived to be a self-consistent sequence of operations or steps or instructions leading to a desired result. The operations or steps are those utilizing physical manipulations of physical quantities. Usually, although not necessarily, these quantities can take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

Another display apparatus is illustrated in FIGS. 7A-8B. Turning now to FIG. 7A, illustrating elongated surfboard display apparatus 70, wherein the elongated surfboard has a dorsal side and a ventral side, the apparatus comprising: triangular base 702 having a raised wide anterior facet raised by support members (legs) 703, 704 and a narrow posterior side that is lower, terminating in a posterior support member 305. Having the three support members 703, 704, 705 is configured to ensure constant and continuous contact with the ground. Also shown is tilted V-shaped support member 701 having basal edge 726 and apical edge 727 (see e.g., FIG. 7A), defining an apically flared slit 715 with basal end 716, configured to receive and engage a posterior ventral fin 805 (see e.g., FIG. 8B) of elongated surfboard 800. As illustrated in FIG. 7A, V-shaped tilted support member 701 can define two arms 721, 722 extending laterally from a single vertical member 710, terminating in a basal end 711, configured to couple to base 701.

The term “V-shaped” shall be construed broadly. For example, V-shaped slit 715 may have any angle of taper. Or, for example, a V-shaped slit in an object may penetrate all of the way through the object, so that tapering sides of the V-shaped slit do not meet. Or, for example, a V-shaped slit in an object may penetrate only part way through the object, so that opposite tapering sides of the V-shaped slit meet within the object. Or, for example, a V-shaped slit may have a “V” that runs in any direction. For example, a “V” may taper (wider to narrower) from right to left or from up to down. Or, for example, a V-shaped slit may have tapering sides that define superimposed, multiple “V”s. For example, one V in a region of the slit may taper (wider to narrower) in one direction (e.g., left to right) and another superimposed V in the same region may taper (wider to narrower) in another direction (e.g., up to down). In another embodiment, the term “V-shaped” is used herein to define a tapered opening which is configured to engage ventral posterior fin 805.

As illustrated in FIG. 7B, tilted, V-shaped support member 701 can be configured to fix board 800 (see e.g., FIG. 8A) at a predetermined pitch angle θ (see e.g., FIG. 7B) of between about 3° and about 25°, for example, between about 5° and about 15°, or about 9°. The pitch angle θ can depend in an embodiment on the dimensions and type of board displayed, the dimensions of base member 702 triangle, and the dimensions of the tilted V-shaped support member, to ensure that center of gravity 801 (see e.g., FIG. 8A) remains substantially above the center point of a circle subsumed in the 2D projection of base 702 (see e.g., FIG. 7D). Dimensions of base (702) triangle can be for example, those configured to provide a 2D projection (defined by support members 703, 704, 705, see e.g., FIG. 7D), of an isosceles triangle with anterior base of about 540 mm and a height of about 270 mm. Likewise, tilted V-shaped support member 701 can have dimensions configured to provide 2D dimensions (defined by basal end 711 and edges of arms 721, 722, see e.g., FIG. 7D), of an isosceles triangle with apical base of about 310 mm and a height of about 190 mm.

Further illustrated in FIGS. 7A-7C is resilient strip 720 operably coupled to apical edge 727 of tilted, V-shaped support member 701.

Turning now to FIGS. 8A, 8B, illustrating the predetermined yaw angle of surfboard 800 displayed on display apparatus 700, with side elevation view of the intended 3-fins (thruster) surfboard illustrated in FIG. 8B. As illustrated, surfboard 800 can further comprise pair of fins 806, 806′, disposed anterior to posterior ventral fin 805. Display apparatus 700 can be configured in an embodiment such that apical edge 727 of tilted V-shaped support member 701 is configured support pair of fins 806, 806′ when posterior ventral fin 805 is engaged at basal end 716 of apically flared slit 715, of tilted V-shaped support member 701.

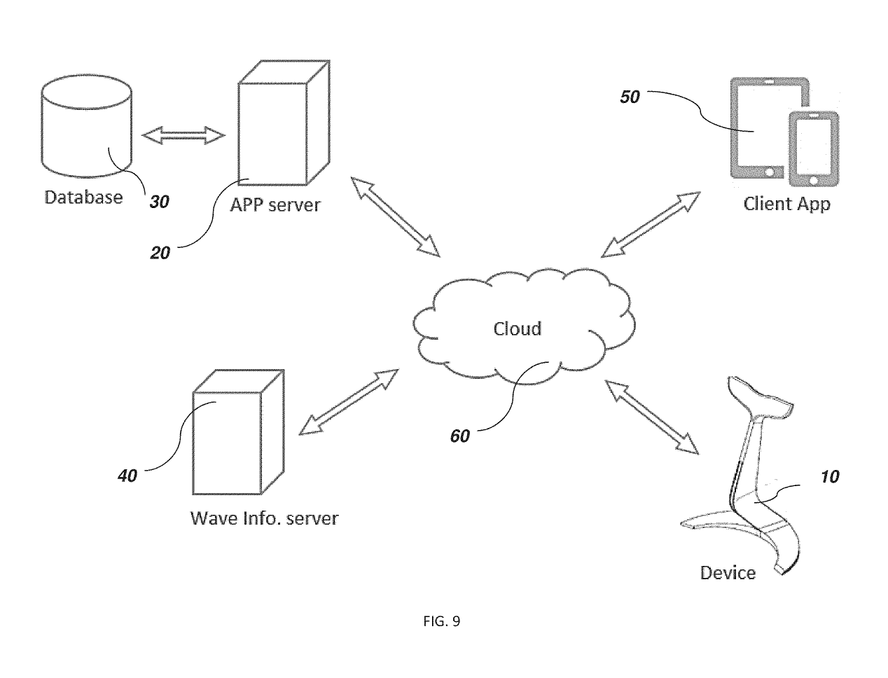

Turning now to FIGS. 9-11 illustrating (See e.g., FIG. 9) a surfing system comprising: display apparatus 10 or 70 having: transceiver 300 (see e.g., FIGS. 4, 7B) operably coupled to tilted support member 100 (or 701) or base 102 (or 702); a display operably coupled to tilted support member 100 (or tilted V-shaped support member 701) or base 102 (or 702): a non-volatile memory, having thereon a computer readable media with executable set of instructions; a processor operably coupled to tilted support member 100 (or tilted V-shaped support member 701) or base 102 (or 702), the processor being in communication with the memory, transceiver 300 and the display; and a power source (not shown); application gateway server 20; mobile device(s) 50; environmental condition server 40; and database 30, wherein display apparatus 10, application gateway server 20, mobile device 50, and environmental conditions server 40 are each in two way communication with each other over wide area network 60. It is noted that in one embodiment in accordance with the disclosure, a general description of “cloud” (see e.g., FIG. 9) can refer to a collection of network-hosted services accessible from almost anywhere with the following attributes: elastically scalable, illusion of infinite capacity, available on-demand, and consumption-based charges with no upfront commitment, but is not limited to such. This description can apply to all levels of the cloud (e.g., process, software application, compute platform, or virtual machine hosting).

Mobile device(s) 50 can comprise at least some or all of the components of the surfing system as a standalone unit. For example, some smart phones or some other handheld units such as a tablet computer, PDA, or small mini-notebooks or pads (hereinafter ‘smart phone’) comprise (e.g. as built in) a programmable processor, a display, a microphone and spare or auxiliary memory as well in some cases connection to external resources such a computers and web sites (e.g. using Bluetooth, WiFi, and/or 3/4G). Likewise, display apparatus 10 can comprise a direct interface with mobile device 50 (a docking port), which can function as the display, processor, transceiver and other communication functions for display apparatus 10.

The data used in the systems and methods provided herein, can be stored on mobile device 50. Likewise, the environmental data can be retrieved form a local storage (e.g., on mobile device(s) 50), such as database 30 using gateway application server 20 or via network 60, such as an internet, LAN, WAN and/or cell phone network.

When the smart phone (and/or another computer) does not comprise or include a required or optional component, an external component can be coupled (e.g. by wire or wirelessly) using a program or an app coded to support the connection and connected component(s). For example, a surf board with a dedicated system of transceiver(s) and sensors may be connected using such a scheme.

The term “application server” or “gateway server” in reference to gatway application server 20, can be directed to a back-end hardware and software product that is used to manage content. Further, the term “dedicated interface” refers to information or content items displayed within a region of a portal web site or a specific application used for a specific event. For example, a dedicated interface can be a component of a portal web site and is a smaller web application that runs on a portal server (e.g., a portlet).

Likewise, mobile device(s) 50, can comprise end user(s) dedicated interfaces. End-user dedicated and/or customized interfaces can be applications that provide the proper queries to access relevant data, provide access for uploading product or service data, upon obtaining permission in the form of, for example, a code or a token, accessing other user-specific data server(s), e.g., application gateway server 20 and the like.

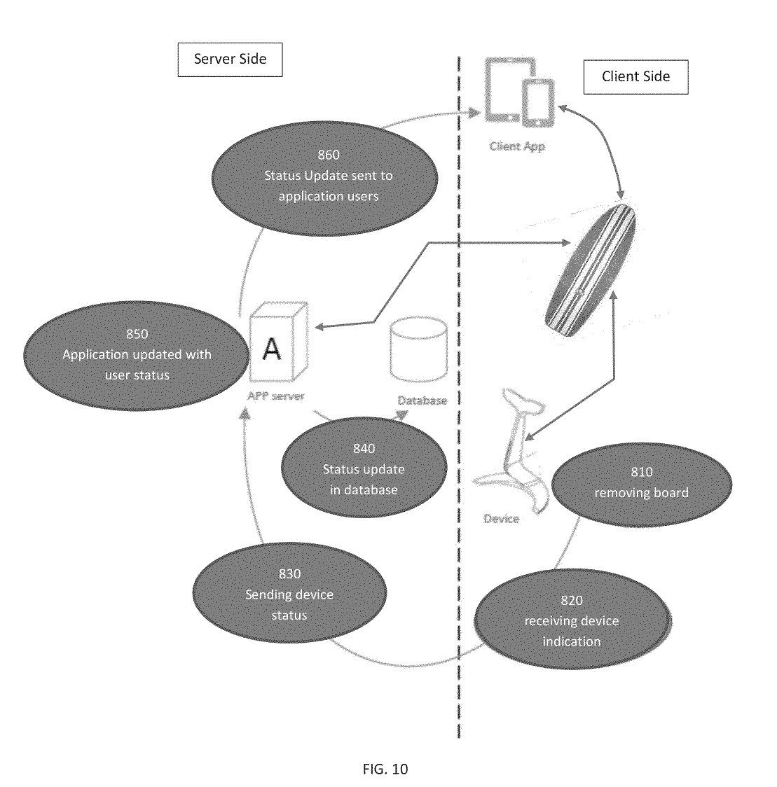

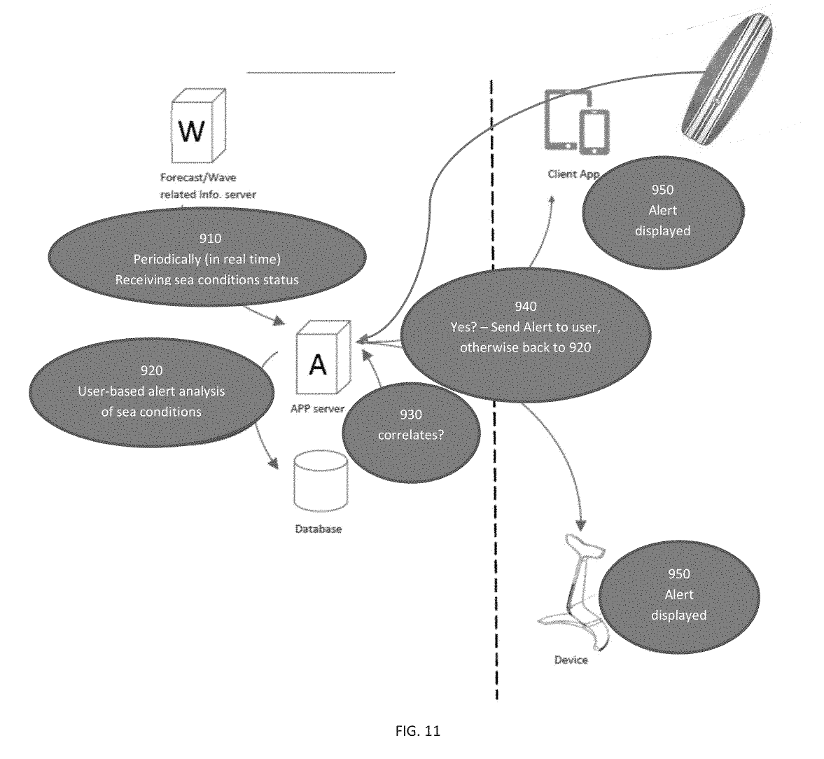

The system can further comprise a load balancer (not shown). A load balancer can be used in the systems implementing the methods described herein and be coupled to network node 60 that may include a processor or a computer coupled to network 60 and that communicates with other processors on the network including clients and servers (see e.g., FIG. 10). A load balancer may be a separate node or may be incorporated into another node such as, for example, gateway application server 20 (see e.g., FIG. 10). A node refers to any device coupled to the network including clients (see e.g., FIG. 11), caches, proxies 40, location determining sensors (e.g., on surfboard 200, see e.g., FIG. 11) and environmental server(s) 40. A “data center”, refers to a group of at least two servers (e.g., gateway application servers FIG. 9, 20 and environmental conditions server) and may include a load balancer.

In an embodiment, the system described herein can further comprise a load balancer in communication with the plurality of wide area network servers, web data servers, node data servers and the like; and the plurality of mobile device(s) 50. The load balancer can communicate as described herein over a large multi-node network, such as (e.g., dedicated) WiLAN. The systems described herein, for implementing the methods provided herein, can further comprise an administrative client device and a business client device in communication with the main gateway application server. The term “server” refers for example to the process that provides the service, or the host computer on which the process operates. Similarly, the term “client”, or “client device” refers in another embodiment to the process or device that makes the request, or the host computer/device on which the process operates. As used herein, the terms “client” and “server” can refer to the processes, rather than the host computers, unless otherwise clear from the context. In addition, the process performed by a server can be broken up to run as multiple processes on multiple hosts (sometimes called tiers, see e.g., FIG. 11) for reasons that include reliability, scalability, security and redundancy, among others.

In addition, provided herein is a non-transitory computer readable storage medium having stored thereon processor-executable software instructions configured to cause a processor to perform the operations associated with the method for purchasing a product or a service or otherwise using the services utilizing mobile device(s) 50 as described herein. These instructions can be, for example, to communicate to the application gateway server the location of the surfer, or a state of the waves at the surfing location, or both.

The term “computer-readable medium” as used herein refers to any medium that participates in providing information to the processor, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

The term “communication” and its derivatives (e.g., “in communication”) may refer to a shared bus configured to allow communication between two or more devices, or to a point to point communication link configured to allow communication between only two (device) points. Likewise, the term “operatively coupled” or “operably coupled” refers to a connection between devices or portions thereof that enables operation in accordance with the present system. For example, an operative coupling may include one or more of a wired connection and/or a wireless connection between two or more devices that enables a one and/or two-way communication path between the devices or portions thereof. In addition, an operable coupling may include a communication path through a wired and/or wireless network, such as a connection utilizing the Internet. The term contact center is utilized herein to describe a support/service center and as such, may be a contact center, call center, etc.

Display apparatus 10 or 70 can be configured to maintain communication with a single end user and participate (in other words send and receive data and communication) when detecting and communicating the presence or absence of the elongated board; and when receiving update(s) from application gateway server 20. In both circumstances, the update can be audio, visual, or audio visual.

Gateway application server 20 can be configured as the backend content management server, direct communication among the system's component, send and receive updates and synchronize data between database 30 and other system components.

Database 30, can be configured to store end users data and other facilities' condition.

Environmental conditions server can be configured to access and retrieve pertinent weather conditions, wave height and the like from various networked resources.

A dedicated server can also be a part of the system, that can be configured to receive and provide updates that are specific to the elongated board used, for example surfing blogs and the like.

Mobile device(s) 50, or end users, can be configured to transmit and receive data, send and receive queries and send and receive status updates.

Turning now to FIG. 10, illustrating a method of status updates using the system described herein, whereby (810) removing board 200 (or 800) from display apparatus 10 (or 70), will trigger apparatus 10 (or 70) to receive an indication (820), through, for example, an audio or visual signal or both, which can be triggered in display apparatus 10 (or 70) or mobile device 50 that may or may not be coupled thereto. The device status can then be communicated (830) to gateway application server 20, which then updates (840) database 30 and on gateway application server 20—itself (850). The status update is then, upon permission, is sent to other end users (860).

Turning now to FIG. 11, illustrating transmission of surfing status in the system. As shown, using environmental conditions server 40, gateway application server can be configured to (910) periodically and in real time, receive update on sea conditions (e.g., wind speed, visibility, wave height etc.) from environmental conditions server 40, or in an embodiment, from end-user's elongated board equipped with a (array) sensor system as described hereinabove. Gateway application server can be configured to (920) compare the data received from environmental conditions server 40 with user-defined alerts stored in database 30 (e.g., alert me when waves are over three feet, wind speed is above 5 knots etc.). Gateway server can be configured to (930) query the database and analyze the data to assess if the sea conditions received correlate positively with the alert, and if so (940), send the alert to display apparatus 10, and end-user's mobile device 50, which then (950) display the alert.

Although illustrated for surfing, the system illustrated in FIGS. 10 and 11 can likewise work for long boarding, snowboarding, skateboarding and the like.

It is contemplated that the power source used in the systems described herein, as well as display apparatus embodiments 10, and/or 70 can be used to power and as docking stations respectively to any networked sensors embedded within the elongated (surf) boards described herein. The docking and charging can be done, for example by induction using pads disposed ventrally on boards 200 and/or 800, which are in electronic communication with the networked sensors. For example, the network sensors can be gyroscopes, accelerometers, torsion sensors, global positioning service sensors and the like, which can be network using various protocols compatible for example with the IIoT, such as OPC unified architecture (OPC-UA), or the Message Queueing Telemetry Transport (MQTT) transfer protocol, or Constrained Application Protocol (CoAP), and the like and/or their combination.

As used herein the term “about” refers to .about. 10%. The terms “comprises”, “comprising”, “includes”, “including”, “having” and their conjugates mean “including but not limited to”.

Throughout this application, various embodiments of the technology may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It should be appreciated that certain features of the disclosed technology, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the technology has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference in its entirety. In addition, citation or identification of any reference in this application shall not be construed as an admission that such reference is available as prior art to the technology described and claimed.

What is claimed is:

1. An elongated board display apparatus, wherein the elongated board has a dorsal side and a ventral side, the apparatus comprising:
a. a base;
b. a tilted elongated support member having a longitudinal axis, a proximal end coupled to the base and a flared distal end configured to abut the elongated board, wherein the tilted elongated support member defines a slit in parallel with the support member's longitudinal axis, wherein:
i. the tilt is configured to fix the board at a predetermined pitch angle; the flared distal end is configured to fix the elongated board at a predetermined roll angle; and
ii. the slit is configured to receive and engage a ventral member on the board and fix the elongated board at a predetermined yaw angle;
c. a transceiver operably coupled to the support member or the base; a display operably coupled to the support member or the base: a non-volatile memory, having thereon a computer readable media with executable set of instructions; a processor operably coupled to the support member or the base, the processor being in communication with the memory, the transceiver and the display; and
d. a power source.

2. The apparatus of claim 1, wherein the tilted support member defines an elbow along the longitudinal axis and wherein the slit spans the elbow.

3. The apparatus of claim 2, wherein the tilted support member further comprises a bar transverse to the support member's longitudinal axis, the bar coupled to the support member at the elbow and is accessible through the slit.

4. The apparatus of claim 1, wherein the elongated board is a surfboard, a stand-up paddle, a skate board, a long board, or a street luge board.

5. The apparatus of claim 1, wherein the flared distal end of the support member abuts the ventral side of the elongated board.

6. The apparatus of claim 1, further comprising a sensor configured to detect and communicate presence or absence of the elongated board on the apparatus.

7. The apparatus of claim 1, wherein the predetermined pitch angle is between 0° and about 45° off vertical.

8. The apparatus of claim 1, wherein the base is floor mounted.

9. The apparatus of claim 1, wherein the flared distal end further comprises a pad composed of a resilient material.

10. The apparatus of claim 1, wherein the elongated board is a surfboard and the ventral member is a fin.

11. An elongated surfboard display apparatus, wherein the elongated surfboard has a dorsal side and a ventral side, the apparatus comprising:
a. a triangular base having a raised wide anterior facet and a narrow posterior side; and
b. a tilted V-shaped support member having a basal edge and an apical edge, defining an apically flared slit with a basal end, configured to receive and engage a posterior ventral fin of the elongated surfboard; and
c. a resilient strip operably coupled to the apical edge of the V-shaped support member.

12. The apparatus of claim 11, wherein the apical edge of the V-shaped support member abuts the ventral side of the surfboard.

13. The apparatus of claim 12, wherein the surfboard further comprises a pair of fins disposed anterior to the posterior ventral fin.

14. The apparatus of claim 13, wherein the apical edge of the tilted V-shaped support member is configured support the pair of fins when the posterior ventral fin is engaged at the basal end of the apically flared slit.

15. A surfing system comprising:
a. the display apparatus of claim 1;
b. an application gateway server;
c. a mobile device;
d. an environmental condition server;
e. a database, wherein the apparatus, the application server the mobile device, and the environmental conditions server are each in two way communication with each other over a wide area network.

16. The system of claim 15, wherein, in the apparatus of claim 1, the elongated board is a surfboard comprising a ventral fin.

17. The system of claim 16, wherein the surfboard further comprises a transceiver configured to communicate with the application server, the apparatus or both over a wide area network.

18. The system of any one of claim 15, wherein the wide area network is a wireless network, a 3G cellular network, a 4G cellular network, a 5G cellular network, Ethernet or a network comprising one or more of the foregoing.

19. The system of claim 15, wherein the mobile device is a smartphone, a phablet, a tablet or a surfboard.

20. The system of claim 15, further comprising a sensor configured to detect and communicate presence or absence of the elongated board on the apparatus.
